(19) United States
(12) Patent Application Publication
(10) Pub. No.: US 2014/0230791 A1
(43) Pub. Date: Aug. 21, 2014

(54) FUEL INJECTION CONTROL SYSTEM FOR AN INTERNAL COMBUSTION ENGINE

(71) Applicants: Susumu Kojima, Susono-shi (JP); Tomojiro Sugimoto, Susono-shi (JP)

(72) Inventors: Susumu Kojima, Susono-shi (JP); Tomojiro Sugimoto, Susono-shi (JP)

(73) Assignee: TOYOTA JIDOSHA KABUSHIKI KAISHA, Toyota-shi, Aichi (JP)

(21) Appl. No.: 14/347,811

(22) PCT Filed: Sep. 28, 2011
(86) PCT No.: PCT/JP2011/072203

§ 371 Date: Mar. 27, 2014

(51) Int. Cl. F02M 69/02

(52) U.S. Cl. CPC F02M 69/02
USPC 123/446

(57) ABSTRACT

In a fuel injection control system for an internal combustion engine provided with a low pressure fuel pump and a high pressure fuel pump, proportional plus integral control of a high pressure fuel pump is carried out to make a pressure of fuel come close to a target value between the high pressure fuel pump and fuel injection valves. In cases where the high pressure fuel pump is in operation, a feed pressure, which is a pressure of fuel between a low pressure fuel pump and the high pressure fuel pump, is caused to go down when an integral term in the proportional plus integral control does not change or is decreasing, and the feed pressure is caused to go up when the integral term is increasing. In cases where the high pressure fuel pump is in a stopped state, the feed pressure is made higher than before the high pressure fuel pump is stopped.

### TECHNICAL FIELD

The present invention relates to a fuel injection control system for an internal combustion engine.

### BACKGROUND ART

In fuel injection control systems for internal combustion engines in which fuel is directly injected into each cylinder, there has been known one which is provided with a low pressure fuel pump that serves to draw up fuel from a fuel tank, and a high pressure fuel pump that serves to cause the fuel thus drawn up by the low pressure fuel pump to rise up to a pressure at which the fuel can be injected into each cylinder.

In the fuel injection control systems as mentioned above, in order to suppress the energy consumption accompanying the operation of the low pressure fuel pump, it is desired to decrease a pressure (also called a feed pressure) at the downstream side of the low pressure fuel pump as much as possible. However, when the feed pressure becomes lower than a saturated vapor pressure of fuel, there will be a fear that fuel vapor may be generated.

In contrast to this, in Patent Document 1, there is described a technique in which in cases where the driving duty of a high pressure fuel pump becomes equal to or greater than a predetermined value, a determination is made that vapor has been generated, thus causing a feed pressure to go up.

However, when a fuel cut is carried out at the time of deceleration of an internal combustion engine, etc., it is not necessary to pressurize fuel to high pressure, so the high pressure fuel pump is stopped. In this case, the driving duty of the high pressure fuel pump becomes zero. Accordingly, it becomes impossible to determine, based on the driving duty of the high pressure fuel pump, whether vapor has been generated or not.

In addition, in cases where the high pressure fuel pump is subjected to proportional plus integral control, fuel economy can be improved by making the feed pressure small based on an integral term. However, when the high pressure fuel pump is in a stopped state, the integral term cannot be obtained, so the feed pressure cannot be made smaller according to the rate of change of the integral term.

### PRIOR ART REFERENCES

### Patent Documents

[Patent Document 1] Japanese patent application laid-open No. 2010-071224

### SUMMARY OF THE INVENTION

### Problems to be Solved by the Invention

The present invention has been made in view of the above-mentioned actual circumstances, and the object of the invention is to provide a technique in which in a fuel injection control system for an internal combustion engine provided with a low pressure fuel pump and a high pressure fuel pump, a feed pressure can be made as low as possible, while suppressing generation of vapor.

### Means for Solving the Problems

In order to achieve the above-mentioned object, a fuel injection control system for an internal combustion engine according to the present invention, in which fuel delivered from a low pressure fuel pump is pressurized by a high pressure fuel pump and is supplied to a fuel injection valve, is provided with:

a pressure sensor to detect a pressure of fuel between said high pressure fuel pump and said fuel injection valve;

a high pressure fuel pump control unit configured to carry out proportional plus integral control of said high pressure fuel pump so that a detected value of said pressure sensor comes close to a target value;

a low pressure fuel pump control unit configured to decrease a feed pressure, which is a pressure of fuel between said low pressure fuel pump and said high pressure fuel pump, when said high pressure fuel pump is in operation and when an integral term in said proportional plus integral control does not change or is decreasing, and to raise said feed pressure when said high pressure fuel pump is in operation and when said integral term is increasing; and

a feed pressure increasing unit configured to make said feed pressure higher when said high pressure fuel pump is in a stopped state than before said high pressure fuel pump is stopped.

The high pressure fuel pump control unit carries out proportional plus integral control in such a manner that a difference between the detected value (actual fuel pressure) of the pressure sensor and the target value becomes small, for example. In this proportional plus integral control, a delivery pressure or a delivery amount of fuel from the high pressure fuel pump is caused to change, for example, by manipulating or controlling electric power to be supplied to the high pressure fuel pump, or the driving duty of the high pressure fuel pump. According to this, the detected value of the pressure sensor is caused to change. In cases where this proportional plus integral control is carried out, when vapor is generated in a fuel path extending from the low pressure fuel pump to the high pressure fuel pump, the integral term of the proportional plus integral control shows an increasing tendency. In this case, the generation of vapor can be suppressed by making the feed pressure high.

Accordingly, in cases where said integral term does not change or decreases, the feed pressure is decreased. Here, note that in cases where the amount of change per unit time of said integral term becomes equal to or less than zero, the feed pressure may be decreased. On the other hand, in cases where said integral term increases, the feed pressure is raised. Here, note that incases where the amount of change per unit time of said integral term becomes larger than zero, the feed pressure may be raised. In that case, it is possible to suppress the feed pressure to a necessary minimum, while avoiding the generation of vapor. For example, the low pressure fuel pump control unit changes the delivery pressure or the delivery amount of fuel from the low pressure fuel pump, so that the feed pressure becomes lower within a range in which vapor is not generated.

However, at the time of deceleration of a vehicle on which the internal combustion engine is mounted, fuel cut to stop the supply of fuel to the internal combustion engine is carried out. The high pressure fuel pump is stopped at the time of the fuel cut. Then, when the high pressure fuel pump is stopped, fuel in fuel piping disposed around the internal combustion engine will receive radiant heat from the internal combustion engine. As a result of this, when the temperature of the fuel rises, vapor may be generated.

That is, when the high pressure fuel pump operates, the fuel in the fuel piping flows and renews soon or quickly, so it is hard to generate vapor. On the other hand, when the high pressure fuel pump is stopped, the fuel will stay in the fuel piping, so that vapor will be easily generated due to the rise in temperature of the fuel which has received heat from the internal combustion engine. Then, when vapor is generated at the time of the stop of the high pressure fuel pump, the rise of fuel pressure will be delayed at the time of the next operation of the high pressure fuel pump.

In addition, the feed pressure control by means of the low pressure fuel pump control unit is processing which is based on the integral term at the time when the proportional plus integral control (PI control) based on the difference between the detected value of the fuel pressure at the downstream side of the high pressure fuel pump and the target value has been carried out . For this reason, when the high pressure fuel pump is stopped, it becomes impossible to carry out the feed pressure control by means of the low pressure fuel pump control unit. That is, it becomes impossible to decide the feed pressure.

Accordingly, the feed pressure increasing unit makes the feed pressure at the time of the high pressure fuel pump being in the stopped state higher than the feed pressure before the high pressure fuel pump is stopped. This may be such that the feed pressure at the time of the stopped high pressure fuel pump is made higher than the feed pressure immediately before the high pressure fuel pump is stopped or at a point in time at which the high pressure fuel pump is stopped. Then, when the high pressure fuel pump is in the stopped state, the feed pressure control by means of the low pressure fuel pump control unit is caused to stop. That is, when the high pressure fuel pump is in operation, the feed pressure is decided by the low pressure fuel pump control unit, but when the high pressure fuel pump is in the stopped state, the feed pressure is decided by the feed pressure increasing unit.

Here, immediately before the high pressure fuel pump is stopped, the feed pressure control by means of the low pressure fuel pump control unit is carried out, so the feed pressure at this time becomes a necessary minimum value at which vapor is not generated. In this state, when the high pressure fuel pump is stopped, the temperature of fuel will go up, and there is a fear that vapor may be generated. In contrast to this, by causing the feed pressure to go up, the generation of vapor can be suppressed. That is, by making the feed pressure higher than that before the high pressure fuel pump is stopped, the generation of vapor can be suppressed. In this manner, it is possible to suppress the feed pressure to a low value, while avoiding the generation of vapor. Here, note that an amount of rise of the feed pressure may be a constant value at which vapor is not generated, but may be decided in a manner as mentioned later.

Moreover, in the present invention, the time when said high pressure fuel pump is in the stopped state may be a time of fuel cut of said internal combustion engine.

Here, at the time of the fuel cut of the internal combustion engine, fuel is not injected from the fuel injection valve, so it is not necessary to operate the high pressure fuel pump. At this time, even if the low pressure fuel pump is operated so that the feed pressure is made to be a pressure level before the fuel cut, there will be a fear that vapor may be generated due to a rise in the temperature of fuel. On the other hand, if the feed pressure is made higher when the fuel cut is carried out than before carrying out the fuel cut, the generation of vapor can be suppressed.

Further, in the present invention, said feed pressure increasing unit may also make said feed pressure higher as a period of time in which said high pressure fuel pump is in the stopped state becomes longer.

Here, the longer the stop period of time of the high pressure fuel pump, the more the heat which the fuel receives from the internal combustion engine increases. For this reason, the longer the stop period of time of the high pressure fuel pump, the higher the temperature of the fuel becomes, and the easier it becomes to generate vapor. In contrast to this, by making the feed pressure higher as the stop period of time of the high pressure fuel pump becomes longer, the generation of vapor can be suppressed. This can be said that the longer the stop period of time of the high pressure fuel pump, the larger is made the amount of rise of the feed pressure from before the high pressure fuel pump is stopped. Thus, by deciding the feed pressure according to the stop period of time of the high pressure fuel pump, it is possible to suppress the generation of vapor as well as to suppress the feed pressure from being raised more than needed. Accordingly, the electric power consumption of the low pressure fuel pump can be reduced, so that the deterioration of fuel economy can be suppressed. Here, note that the feed pressure may be raised in a stepwise manner at a predetermined interval, or may be raised continuously in a stepless manner.

In addition, in the present invention, said feed pressure increasing unit may also operate said low pressure fuel pump in an intermittent manner.

Here, when the high pressure fuel pump is in the stopped state, it is sufficient to operate the low pressure fuel pump so as to maintain the feed pressure at a level at which vapor is not generated. That is, because the high pressure fuel pump is in the stopped state, it is difficult for the pressure of the fuel to drop, so it is not always necessary to operate the low pressure fuel pump, but it is only necessary to operate it intermittently, if needed. Accordingly, the electric power consumption of the low pressure fuel pump can be reduced, thus making it possible to improve fuel economy. Here, note that the period of time in which the low pressure fuel pump is made to operate and the period of time in which the low pressure fuel pump is made to stop (i.e., is in the stopped state), respectively, are set in such a manner that the feed pressure is made to be at such a level at which vapor is not generated.

Moreover, in the present invention, said feed pressure increasing unit may also make said feed pressure higher as a temperature of cooling water in said internal combustion engine is higher.

Here, the higher the temperature of the cooling water in the internal combustion engine, the more the heat received by the fuel from the internal combustion engine increases, so the easier it becomes for vapor to be generated. That is, there is a correlation between the temperature of the cooling water and the ease of the generation of vapor. In contrast to this, by making the feed pressure higher as the temperature of the cooling water in the internal combustion engine is higher, the generation of vapor can be suppressed. In addition, when the temperature of the cooling water in the internal combustion engine is low, the electric power consumption of the low pressure fuel pump can be reduced, thus making it possible to improve fuel economy.

Further, in the present invention, said feed pressure increasing unit may also make said feed pressure higher as a difference between the temperature of the cooling water in said internal combustion engine and the temperature of intake air is higher.

Here, the cooling water temperature has a high correlation with the temperature of the internal combustion engine. On the other hand, the temperature of the intake air has a high correlation with the temperature of the fuel. For this reason, the difference between the temperature of the cooling water in the internal combustion engine and the temperature of the intake air in the internal combustion engine is in a correlation with the amount of the heat which the fuel receives from the internal combustion engine. Accordingly, by increasing the feed pressure according to the difference between the temperature of the cooling water in the internal combustion engine and the temperature of the intake air in the internal combustion engine, it is possible to increase the feed pressure according to the amount of the heat received by the fuel. In this manner, when the amount of the heat received by the fuel is large, the generation of vapor can be suppressed. On the other hand, when the amount of the heat received by the fuel is small, the electric power consumption of the low pressure fuel pump can be reduced, thus making it possible to improve fuel economy.

### Advantageous Effect of the Invention

According to the present invention, in a fuel injection control system for an internal combustion engine provided with a low pressure fuel pump and a high pressure fuel pump, it is possible to make feed pressure as low as possible, while suppressing generation of vapor.

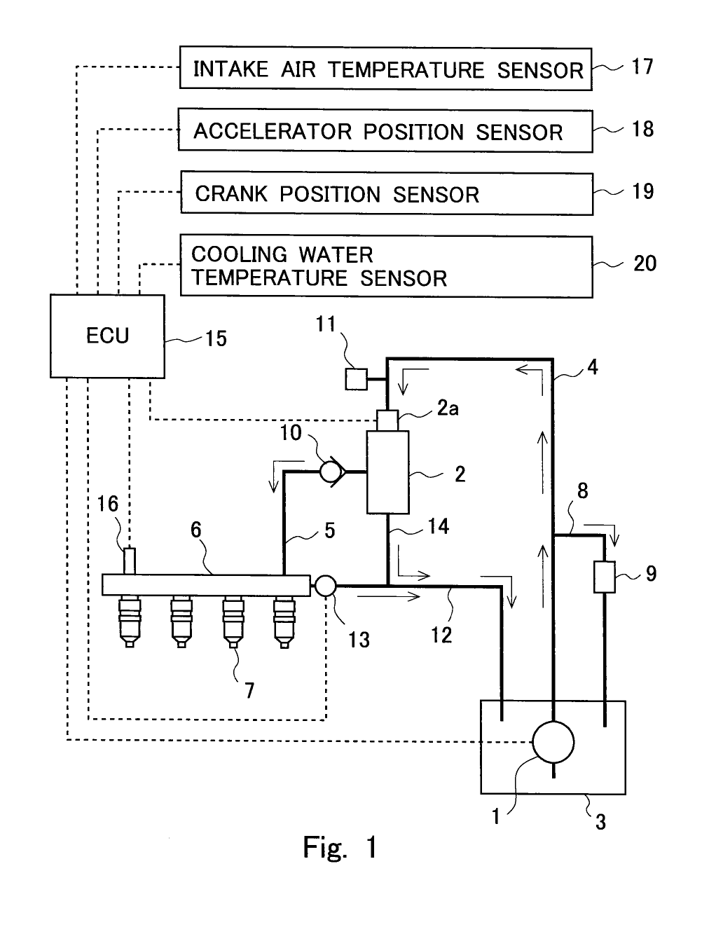

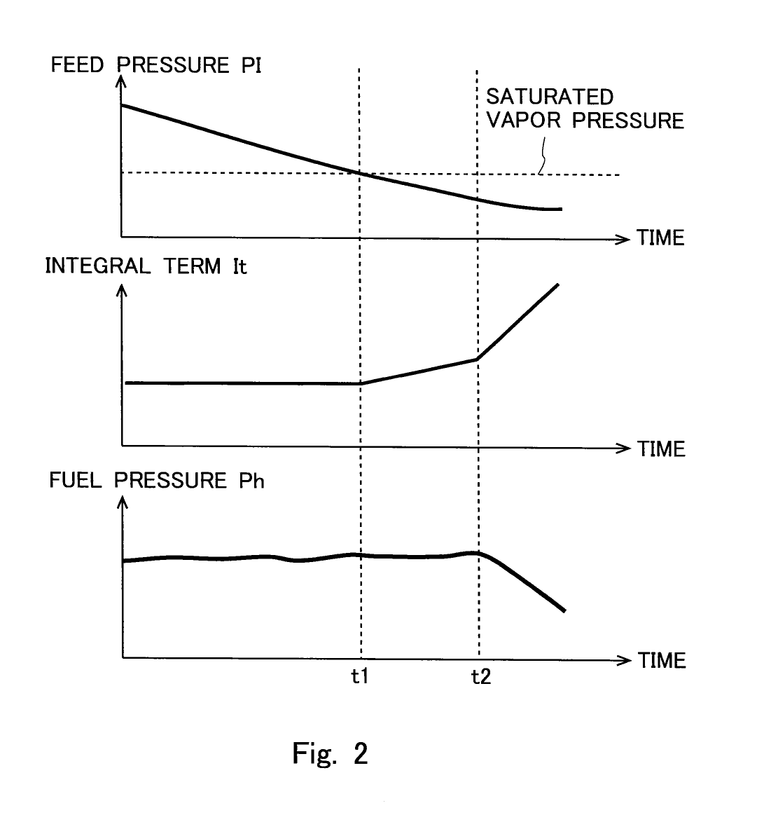

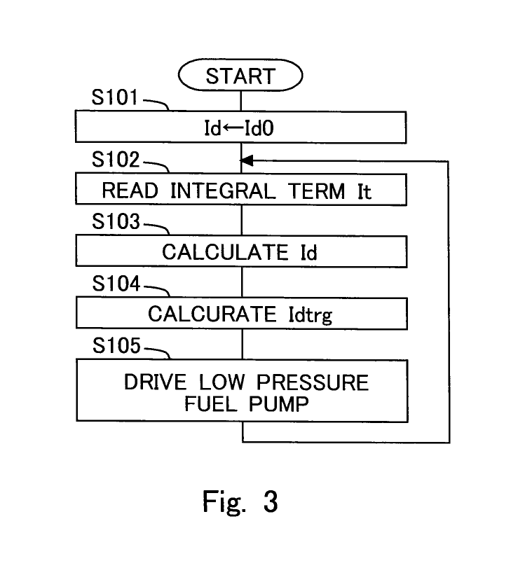

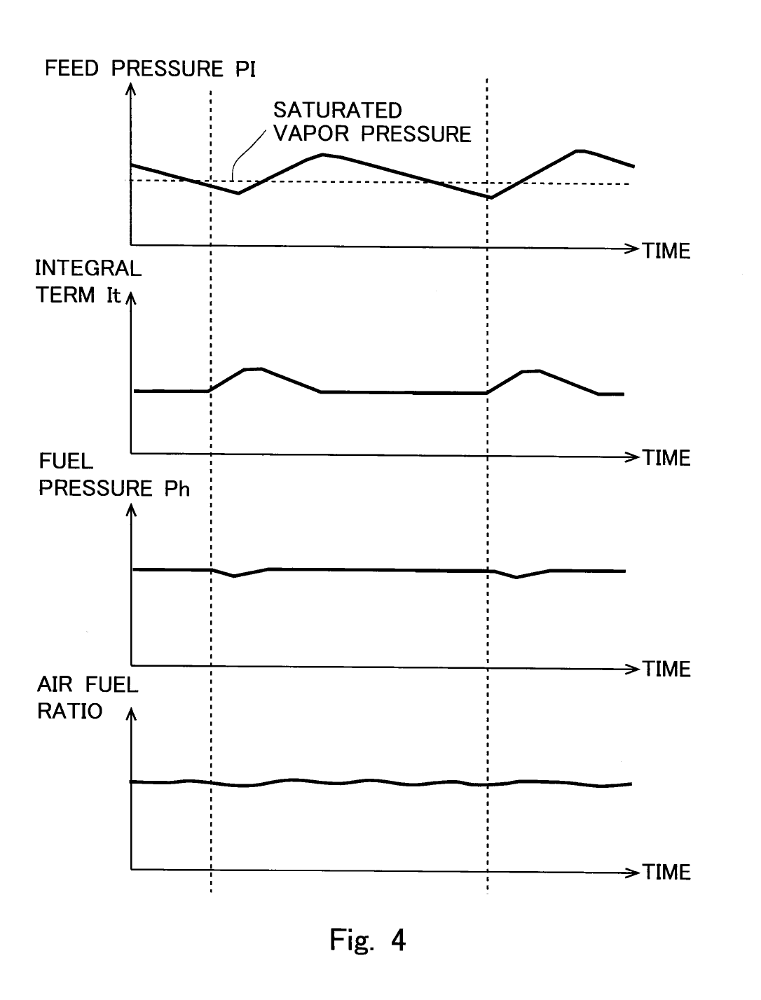

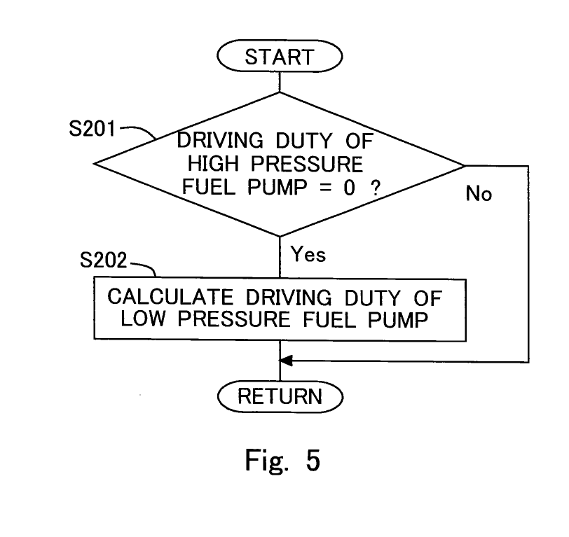

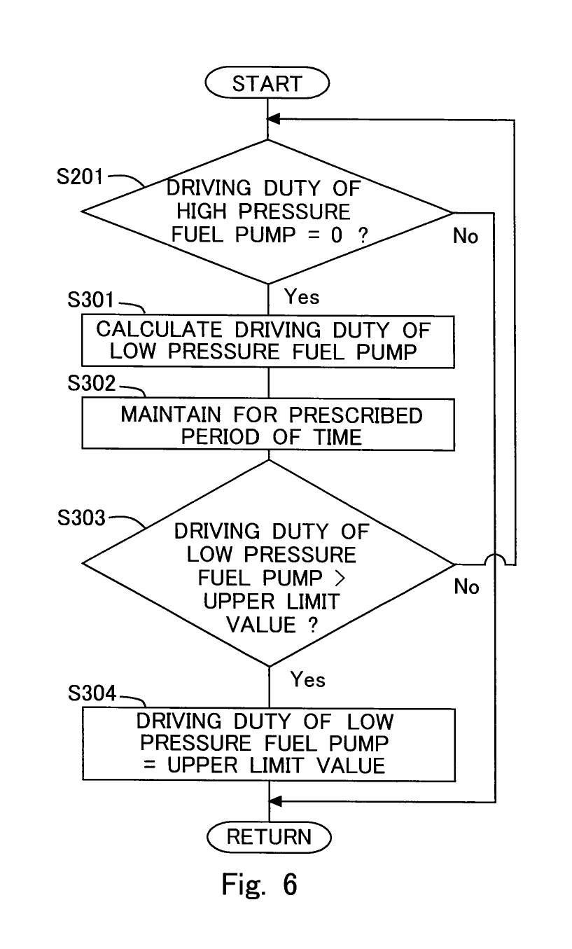

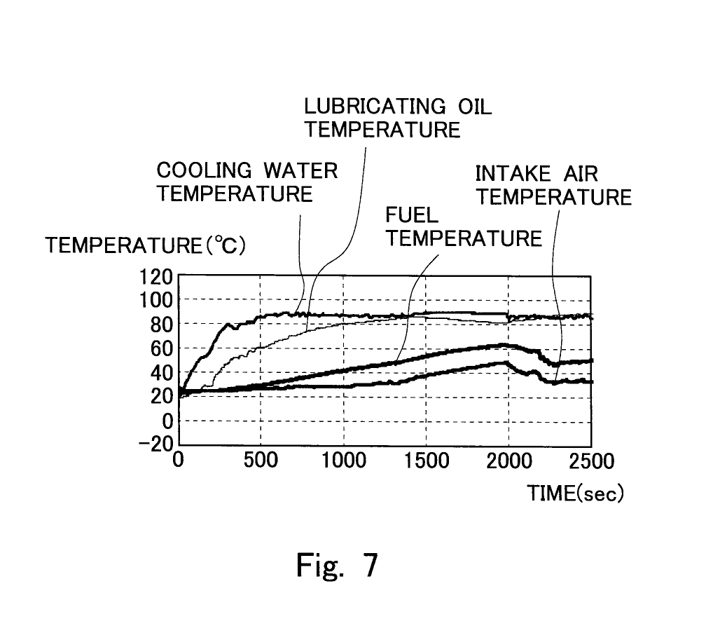

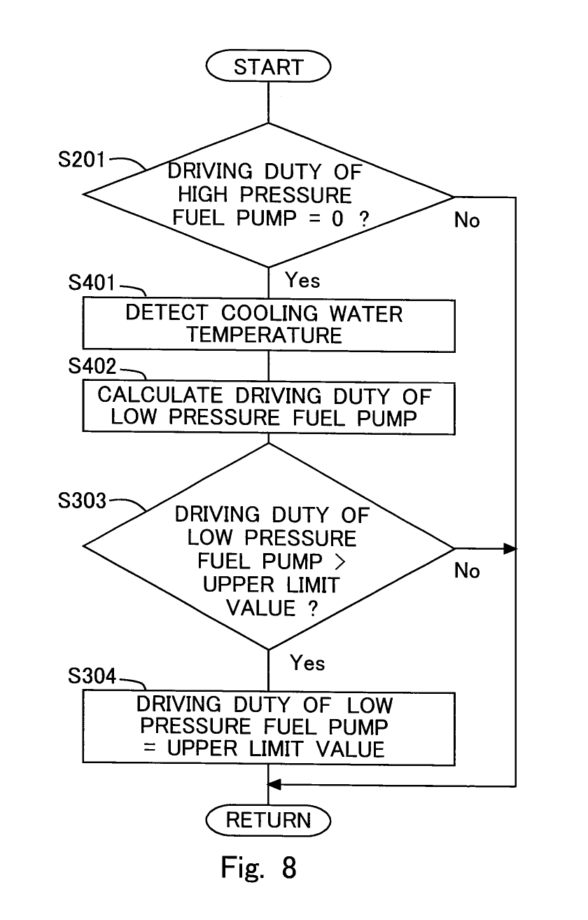

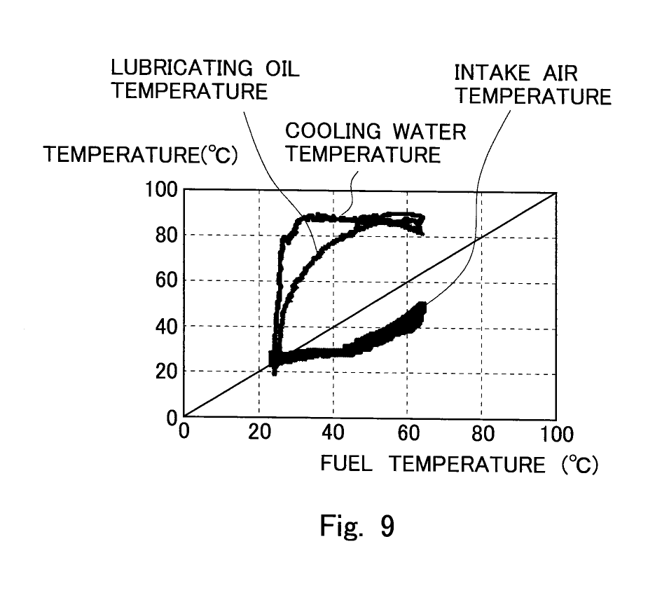

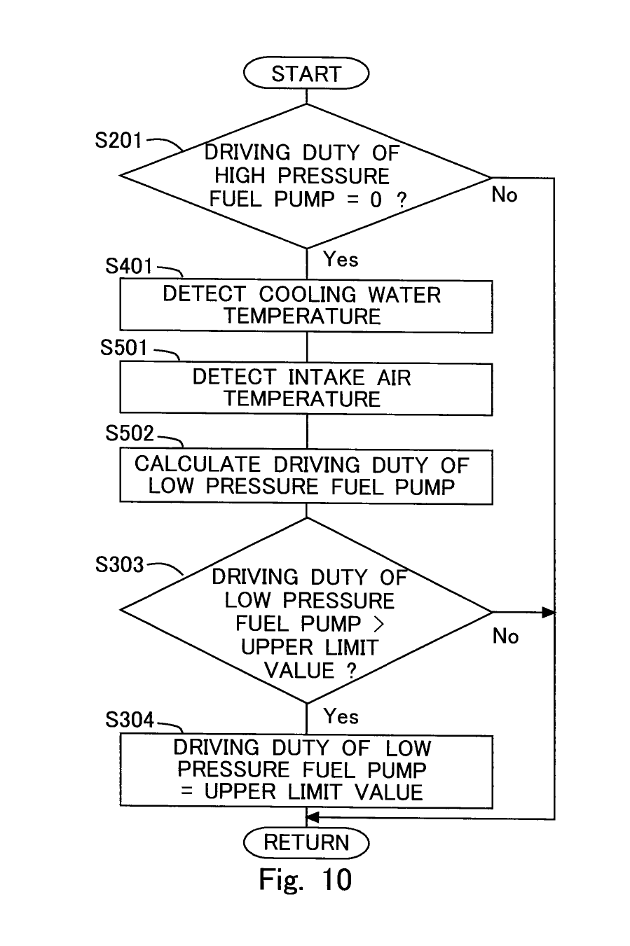

### BRIEF DESCRIPTION OF THE DRAWINGS

[FIG. 1] FIG. 1 is a view showing the schematic construction of a fuel injection control system for an internal combustion engine.

[FIG. 2] FIG. 2 is a view showing the behaviors of an integral term It and a fuel pressure Ph in a high pressure fuel passage in the case of continuously decreasing a delivery pressure (feed pressure) Pl of a low pressure fuel pump.

[FIG. 3] FIG. 3 is a flow chart showing a flow of feed pressure control to decrease the feed pressure Pl of the low pressure fuel pump to a necessary minimum value.

[FIG. 4] FIG. 4 is a view showing the behaviors of the feed pressure Pl, the integral term It, the fuel pressure Ph, and an air fuel ratio, when the feed pressure control shown in FIG. 3 is carried out.

[FIG. 5] FIG. 5 is a flow chart showing a flow of the feed pressure control when a high pressure fuel pump is in a stopped state.

[FIG. 6] FIG. 6 is a flow chart showing a flow of the feed pressure control at the time of increasing the driving duty of the low pressure fuel pump according to a stop period of time of the high pressure fuel pump.

[FIG. 7] FIG. 7 is a time chart showing the changes over time of the temperature of fuel, the temperature of cooling water, and the temperature of intake air, and the temperature of lubricating oil, at the time of traveling of a vehicle.

[FIG. 8] FIG. 8 is a flow chart showing a flow of the feed pressure control at the time of deciding the driving duty of the low pressure fuel pump according to the temperature of the cooling water in the internal combustion engine.

[FIG. 9] FIG. 9 is a view showing the relation among the temperature of the fuel, the temperature of the cooling water, the temperature of the lubricating oil, and the temperature of the intake air, at the time of traveling of the vehicle.

[FIG. 10] FIG. 10 is a flow chart showing a flow of the feed pressure control at the time of deciding the driving duty of the low pressure fuel pump according to the temperature of the cooling water in the internal combustion engine.

### EMBODIMENTS FOR CARRYING OUT THE INVENTION

Hereinafter, a specific embodiment of the present invention will be described based on the attached drawings. However, the dimensions, materials, shapes, relative arrangements and so on of component parts described in this embodiment are not intended to limit the technical scope of the present invention to these alone in particular as long as there are no specific statements.

### First Embodiment

FIG. 1 is a view showing the schematic construction of a fuel injection control system for an internal combustion engine. The fuel injection control system shown in FIG. 1 is one applied to an internal combustion engine having in-line four cylinders, and is provided with a low pressure fuel pump 1 and a high pressure fuel pump 2. Here, note that the number of cylinders of the internal combustion engine is not limited to four, but may be five or more, or may be three or less.

The low pressure fuel pump 1 is a pump for pumping or drawing up fuel stored in a fuel tank 3, and is a turbine type pump (WESCO type pump) which is driven by electric power. The fuel delivered from the low pressure fuel pump 1 is led to a suction port of the high pressure fuel pump 2 through a low pressure fuel passage 4.

The low pressure fuel pump 1 is a pump for pressurizing the fuel delivered from the low pressure fuel pump 1, and is a reciprocating type pump (plunger type pump) which is driven by the power of the internal combustion engine (e.g., a rotating force of a cam shaft). In the suction port of the high pressure fuel pump 2A, there is disposed a suction valve 2a for changing over between opening and closure of the suction port. The suction valve 2a is a valve mechanism of an electromagnetic drive type, and changes an amount of discharge or delivery (or this may be a pressure of delivery) of the high pressure fuel pump 2 by changing the opening and closing timing thereof with respect to the position of a plunger. In addition, a high pressure fuel passage 5 has one end thereof connected to a delivery port of the high pressure fuel pump 2. The high pressure fuel passage 5 has the other end thereof connected to a delivery pipe 6.

Four fuel injection valves 7 are connected to the delivery pipe 6, so that the high pressure fuel pressure fed from the high pressure fuel pump 2 to the delivery pipe 6 is distributed to each of the fuel injection valves 7. Each of the fuel injection valves 7 serves to inject fuel directly into a corresponding cylinder of the internal combustion engine.

Here, note that in cases where fuel injection valves for port injection for injecting fuel to the interiors of intake passages (intake ports), respectively, are mounted on the internal combustion engine, in addition to the fuel injection valves for cylinder injection such as the above-mentioned fuel injection valves 7, it may be constructed such that fuel of low pressure is supplied to delivery pipes for port injection which are branched from the middle of the low pressure fuel passage 4.

A pulsation damper 11 is disposed in the middle of the above-mentioned low pressure fuel passage 4. The pulsation damper 11 is to damp the pulsation of fuel resulting from the operations (suction operation and delivery operation) of the above-mentioned high pressure fuel pump 2. In addition, a branch passage 8 has one end thereof connected to the middle of the above-mentioned low pressure fuel passage 4. The branch passage 8 has the other end thereof connected to the fuel tank 3. A pressure regulator 9 is disposed in the middle of the branch passage 8. The pressure regulator 9 is constructed such that it is opened at the time when the pressure (fuel pressure) in the low pressure fuel passage 4 exceeds a predetermined value, whereby surplus fuel in the low pressure fuel passage 4 returns to the fuel tank 3 through the branch passage 8.

A check valve 10 is disposed in the middle of the above-mentioned high pressure fuel passage 5. The check valve 10 permits a flow going to the above-mentioned delivery pipe 6 from the delivery port of the above-mentioned high pressure fuel pump 2, but restricts a flow going to the delivery port of the above-mentioned high pressure fuel pump 2 from the above-mentioned delivery pipe 6.

A return passage 12 for returning the surplus fuel in the above-mentioned delivery pipe 6 to the above-mentioned fuel tank 3 is connected to the delivery pipe 6. In the middle of the return passage 12, a relief valve 13 is disposed which serves to change over between communication and blocking of the return passage 12. The relief valve 13 is a valve mechanism of an electromotive type or an electromagnetic drive type, and is opened when the fuel pressure in the delivery pipe 6 exceeds a target value.

A communication passage 14 has one end thereof connected to the middle of the above-mentioned return passage 12. The above-mentioned communication passage 14 has the other end thereof connected to the above-mentioned high pressure fuel pump 2. This communication passage 14 is a passage for introducing the surplus fuel discharged from the above-mentioned high pressure fuel pump 2 to the above-mentioned return passage 12.

Here, the fuel supply system in this embodiment is provided with an ECU 15 for electrically controlling the above-mentioned individual equipment. The ECU 15 is an electronic control unit which is provided with a CPU, a ROM, a RAM, a backup RAM, and so on. The ECU 15 is electrically connected to a variety of kinds of sensors such as a pressure sensor 16, an intake air temperature sensor 17, an accelerator position sensor 18, a crank position sensor 19, a cooling water temperature sensor 20, and so on.

The pressure sensor 16 is a sensor which outputs an electrical signal correlated with the fuel pressure (the delivery pressure of the high pressure fuel pump) Ph in the delivery pipe 6. According to the pressure sensor 16, the pressure of the fuel between the high pressure fuel pump 2 and the fuel injection valves 7 can be detected. The intake air temperature sensor 17 outputs an electrical signal correlated with the temperature of air sucked into the internal combustion engine. According to the intake air temperature sensor 17, the temperature of the intake air in the internal combustion engine can be detected. The accelerator position sensor 18 outputs an electrical signal correlated with an amount of operation of an accelerator pedal (i.e., a degree of opening of an accelerator). By the output signal of the accelerator position sensor 18, the load of the internal combustion engine is detected. The crank position sensor 19 is a sensor which outputs an electrical signal correlated with the rotational position of an output shaft (crankshaft) of the internal combustion engine. By the output signal of the crank position sensor 19, the number of revolutions per unit time of the internal combustion engine is detected. The cooling water temperature sensor 20 outputs an electrical signal correlated with the temperature of cooling water in the internal combustion engine. According to the cooling water temperature sensor 20, the temperature of the cooling water in the internal combustion engine or the temperature of the internal combustion engine can be detected.

The ECU 15 controls the low pressure fuel pump 1, the suction valve 2a, etc. , based on the output signals of the above-mentioned variety of kinds of sensors. For example, the ECU 15 regulates the opening and closing timing of the suction valve 2a so that a detected value (actual fuel pressure) of the pressure sensor 16 is converged to a target value. At that time, the ECU 15 carries out proportional plus integral control (PI control) based on a difference between the actual fuel pressure and the target value, by changing the driving duty of the suction valve 2a (the ratio between the time of energization of a solenoid and the time of non-energization thereof). Here, note that this proportional plus integral control is hereinafter also referred to as proportional plus integral control of the high pressure fuel pump 2. In addition, the driving duty of the suction valve 2a is also referred to as the driving duty of the high pressure fuel pump 2. Here, note that the above-mentioned target value is a value which is set in accordance with a target amount of fuel injection of each fuel injection valve 7. In addition, in this embodiment, the actual fuel pressure is brought close to the target value by regulating the opening and closing timing of the suction valve 2a. On the other hand, the amount of delivery from the high pressure fuel pump 2 may be able to be regulated by regulating the power supplied to the high pressure fuel pump 2. In this case, the actual fuel pressure may be brought close to the target value by regulating the power supplied to the high pressure fuel pump 2. In other words, the supply power may be changed by means of proportional plus integral control.

In above-mentioned proportional plus integral control, the ECU 15 calculates the driving duty of the high pressure fuel pump 2, by adding a feed forward term which is decided according to the target amount of fuel injection, a proportional term which is set according to the magnitude of the difference between the actual fuel pressure and the target value (hereinafter also referred to as a “fuel pressure difference”), and an integral term which is obtained by integrating a part of the difference between the actual fuel pressure and the target value, to one another. Here, note that in this embodiment, the ECU 15, which calculates the driving duty of the high pressure fuel pump 2 in this manner, corresponds to a high pressure fuel pump control unit according to the present invention.

Here, note that the relation between the target amount of fuel injection and the feed forward term as well as the relation between the above-mentioned fuel pressure difference and the proportional term are assumed to be decided in advance by adaptation operations making use of experiments, etc. In addition, it is assumed that the proportion of an amount to be added to the integral term, of the above-mentioned fuel pressure difference, is also decided in advance by adaptation operations making use of experiments, etc.

In addition, the ECU 15 carries out feed pressure control to decrease the delivery pressure (feed pressure) of the low pressure fuel pump 1 to a necessary minimum value, in order to reduce the electric power consumption of the low pressure fuel pump 1 as much as possible. Here, note that, the necessary minimum value of the feed pressure may also be set as a lower limit value of the feed pressure at which vapor is not generated.

Specifically, the ECU 15 calculates a driving duty Id of the low pressure fuel pump 1 according to the following expression (1). Here, note that the magnitude of the driving duty Id of the low pressure fuel pump 1 is assumed be proportional to a feed pressure Pl of the low pressure fuel pump 1. That is, the larger the driving duty Id of the low pressure fuel pump 1 is made, the higher becomes the feed pressure Pl.

Id=Idold+ΔIt*F−Cdwn (1)

Idold in expression (1) is the last calculated value of the driving duty Id of the low pressure fuel pump 1. Alt in expression (1) is an amount of change Alt of the integral term It used for the above-mentioned proportional plus integral control (e.g., a difference (It−Itold) between an integral term It used for the current calculation operation and an integral term Itold used for the last calculation operation, of the driving duty of the high pressure fuel pump 2). In addition, the amount of change Alt of the integral term It may also be set as an amount of change per unit time of the integral term It. F in expression (1) is a correction coefficient. Here, note that, as the correction coefficient F, an increase coefficient Fi, being equal to or larger than 1, is used when the amount of change Alt of the integral term It is a positive value, whereas a decrease coefficient Fd, being less than 1, is used when the amount of change Alt of the integral term It is a negative value. In addition, Cdwn in expression (1) is a down or reduction constant. This down constant Cdwn is set for reducing the pressure of delivery of the low pressure fuel pump 1. Here, note that when the pressure of delivery of the low pressure fuel pump 1 reduces quickly, there will be a possibility that the fuel pressure in the low pressure fuel passage 4 may become significantly below a saturated vapor pressure of fuel. In that case, a large amount of vapor will be generated in the low pressure fuel passage 4, thus inducing poor suction, poor discharge or delivery, etc., of the high pressure fuel pump 2. For that reason, it is desirable to set the down constant Cdwn to a maximum value within a range in which the fuel pressure in the low pressure fuel passage 4 does not become significantly below the saturated vapor pressure thereof, and the down constant Cdwn has been obtained in advance by adaptation processing such as experiments, etc.

After the driving duty Id of the low pressure fuel pump 1 is decided according to the above-mentioned expression (1), when the above-mentioned integral term It shows an upward or increasing tendency (ΔIt>0), the driving duty Id of the low pressure fuel pump 1 will increase (i.e., the feed pressure Pl will go up), whereas when the integral term It shows a downward or decreasing tendency or a constant value (ΔIt≦0), the driving duty Id of the low pressure fuel pump 1 will decrease (the feed pressure Pl will go down).

The above-mentioned integral term It shows the increasing tendency, when vapor has been generated in the low pressure fuel passage 4, or stated in another way, when the fuel pressure in the low pressure fuel passage 4 becomes lower than the saturated vapor pressure of the fuel. Here, FIG. 2 is a view showing the behaviors of the integral term It and fuel pressure Ph in the high pressure fuel passage 5 in the case of continuously decreasing the delivery pressure (feed pressure) Pl of the low pressure fuel pump 1.

In FIG. 2, when the feed pressure Pl becomes lower than the saturated vapor pressure (t1 in FIG. 2), the integral term It shows a gradually increasing tendency. After that, when the feed pressure Pl is further decreased, poor suction or poor discharge of the high pressure fuel pump 2 will occur (t2 in FIG. 2). When poor suction or poor discharge of the high pressure fuel pump 2 occurs, the increasing speed of the integral term It becomes large, and the fuel pressure Ph in the high pressure fuel passage 5 decreases.

Accordingly, after the driving duty Id of the low pressure fuel pump 1 is decided according to the above-mentioned expression (1), when the above-mentioned integral term It shows the increasing tendency (ΔIt>0), the feed pressure Pl of the low pressure fuel pump 1 will go up. On the other hand, when the integral term It shows the constant or decreasing tendency (ΔIt≦0), the feed pressure Pl of the low pressure fuel pump 1 will go down. As a result of this, it is possible to reduce the feed pressure Pl of the low pressure fuel pump to the necessary minimum value, while suppressing the poor suction and poor discharge of the high pressure fuel pump 2 resulting from the generation of vapor. Here, note that in this embodiment, the ECU 15, which regulates the driving duty Id of the low pressure fuel pump 1 according to the above-mentioned expression (1), corresponds to a low pressure fuel pump control unit according to the present invention. In addition, as long as the feed pressure Pl of the low pressure fuel pump 1 is caused to go up when the integral term It shows the increasing tendency, and the feed pressure Pl of the low pressure fuel pump 1 is caused to go down when the integral term It shows the constant or decreasing tendency, there may be adopted other calculation expressions than the above-mentioned expression (1).

FIG. 3 is a flow chart showing a flow or routine for feed pressure control to decrease the feed pressure Pl of the low pressure fuel pump to the necessary minimum value. This routine has been beforehand stored in the ROM of the ECU 15, and is executed by using, as a trigger, the starting of the internal combustion engine (e.g., at the time when an ignition switch is changed over from an off state into an on state).

In the routine shown in FIG. 3, the ECU 15 first carries out the processing of step S101. That is, the ECU 15 sets the driving duty Id of the low pressure fuel pump 1 to an initial value Id0. For this initial value Id0, an optimum value has been beforehand obtained through experiments, etc., and stored in the ECU 15.

In step S102, the ECU 15 reads in the value of the integral term It used for the calculation of the driving duty Dh of the high pressure fuel pump 2. Subsequently, the ECU 15 calculates the amount of change ΔIt (=It−Itold) by subtracting the last integral term Itold from the integral term It read in the above-mentioned step S102.

In step S103, the ECU 15 calculates the driving duty Id of the low pressure fuel pump 1 by using the amount of change ΔIt calculated in the above-mentioned step S102 and the down constant Cdwn. At that time, the ECU 15 calculates the driving duty Id of the low pressure fuel pump 1 according to the above-mentioned expression (1).

Here, when the above-mentioned amount of change ΔIt shows a positive value (i.e., when the integral term It shows the increasing tendency), the driving duty Id of the low pressure fuel pump 1 is made to increase. In that case, the pressure of delivery (the feed pressure) Pl of the low pressure fuel pump 1 goes up. On the other hand, when the amount of change ΔIt is zero (i.e. , when the integral term It is constant), or when the integral term It shows a negative value (i.e., when the integral term It is in the decreasing tendency), the driving duty Id of the low pressure fuel pump 1 is decreased. In that case, the pressure of delivery (the feed pressure) Pl of the low pressure fuel pump 1 reduces.

Then, in step S104, the ECU 15 carries out guard processing for the driving duty Id of the low pressure fuel pump 1 obtained in the above-mentioned step S103. That is, the ECU 15 determines whether the driving duty Id of the low pressure fuel pump 1 obtained in the above-mentioned step S103 is a value which is equal to more than a lower limit value and which is equal to or less than an upper limit value. When the driving duty Id of the low pressure fuel pump 1 obtained in the above-mentioned step S103 is a value which is equal to or more than the lower limit value and which is equal to or less than the upper limit value, the ECU 15 sets the driving duty Id as a target driving duty Idtrg. In cases where the driving duty Id exceeds the upper limit value, the ECU 15 sets the target driving duty Idtrg to the same value as the upper limit value. On the other hand, in cases where the driving duty Id is less than the lower limit value, the ECU 15 sets the target driving duty Idtrg to the same value as the lower limit value.

In step S105, the ECU 15 drives the low pressure fuel pump by applying the target driving duty Idtrg set in the above-mentioned step S104 to the low pressure fuel pump 1. Here, note that after the execution of the processing of step S105, the ECU 15 carries out the processing of step S102 and onwards in a repeated manner.

As described above, in cases where the ECU 15 carries out the feed pressure control shown in FIG. 3, when the integral term It shows the constant or decreasing tendency (i.e., when the amount of change ΔIt becomes a value equal to or less than zero), the pressure of delivery of the low pressure fuel pump 1 is caused to go down. On the other hand, when the integral term It shows the increasing tendency, the pressure of delivery of the low pressure fuel pump 1 is caused to go up (when the amount of change ΔIt shows a positive value).

Accordingly, according to this embodiment, it is possible to stop the reduction of the feed pressure Pl, before a large amount of vapor is generated in the low pressure fuel passage 4 (or this may be at the time when vapor begins to be generated). As a result, it becomes possible to reduce the feed pressure Pl as much as possible, without causing a substantial reduction of the fuel pressure Ph or disturbance of an air fuel ratio, as shown in FIG. 4. Here, FIG. 4 is a view showing the behaviors of the feed pressure Pl, the integral term It, the fuel pressure Ph, and the air fuel ratio, when the feed pressure control shown in FIG. 3 is carried out.

In addition, the larger the amount of change ΔIt, the higher the feed pressure Pl is made, so it becomes possible to suppress poor suction and poor discharge of the high pressure fuel pump 2 in a more reliable manner. In addition, the feed pressure control shown in FIG. 3 requires neither any sensor to detect the fuel pressure in the low pressure fuel passage 4, nor any sensor to detect the saturated vapor pressure of the fuel, as a result of which neither reduction in vehicle mountability of the fuel injection control system nor an increase in the cost of manufacture is caused.

However, at the time of deceleration of a vehicle on which the internal combustion engine is mounted, fuel cut to stop the supply of fuel to the internal combustion engine is carried out. The high pressure fuel pump 2 is stopped at the time of this fuel cut. Here, the fuel in the low pressure fuel passage 4 disposed around the internal combustion engine receives heat from the internal combustion engine. As a result of this, the temperature inside the low pressure fuel passage 4 goes up. At the time of the operation of the high pressure fuel pump 2, the fuel in the low pressure fuel passage 4 flows and renews in a quick manner. For this reason, the rise of the temperature of the fuel is suppressed, so it is hard to generate vapor.

When the high pressure fuel pump 2 is stopped, however, fuel stays in the low pressure fuel passage 4, so that the temperature of the fuel becomes easy to go up, and hence vapor is generated easily. The above-mentioned feed pressure control is processing which is based on the integral term at the time when the proportional plus integral control (PI control) based on the difference between the actual fuel pressure and the target value has been carried out, and hence, when the high pressure fuel pump 2 is stopped, it becomes impossible to carry out the feed pressure control. That is, it becomes impossible to decide the driving duty Id of the low pressure fuel pump 1.

Accordingly, in this embodiment, when the high pressure fuel pump 2 has been stopped (i.e., in a stopped state), the driving duty of the low pressure fuel pump 1 is decided based on a value immediately before the stop of the high pressure fuel pump 2. Here, note that when the high pressure fuel pump is in the stopped state, the feed pressure control as shown in FIG. 3 is caused to stop. Then, the driving duty of the low pressure fuel pump 1 is made a value which is larger with respect to that immediately before the stop of the high pressure fuel pump 2. Here, note that not only when the high pressure fuel pump 2 is in the stopped state, but also when the internal combustion engine is in an operating state where the high pressure fuel pump 2 can be stopped, the driving duty of the low pressure fuel pump 1 may also be made a value which is larger with respect to that immediately before the stop of the high pressure fuel pump 2. As the operating state where the high pressure fuel pump 2 can be stopped, there can be mentioned by way of example a time of fuel cut (i.e., a fuel cut operation).

Here, immediately before the high pressure fuel pump is stopped, the feed pressure control as shown in FIG. 3 is carried out, so the driving duty of the low pressure fuel pump 1 at this time becomes a necessary minimum value at which vapor is not generated. In this state, when the high pressure fuel pump 2 is stopped, the temperature of the fuel in the low pressure fuel passage 4 goes up. Accordingly, in order to suppress the generation of vapor, the driving duty of the low pressure fuel pump 1 need only be made larger than the value immediately before the stop of the high pressure fuel pump 2. As a result of this, the pressure of the fuel in the low pressure fuel passage 4 goes up, so that the generation of vapor can be suppressed. Here, note that an amount of increase in the driving duty of the low pressure fuel pump 1 at this time has been beforehand obtained through experiments, etc., as a value at which the feed pressure becomes higher than the saturated vapor pressure.

FIG. 5 is a flow chart showing a flow or routine for the feed pressure control at the time when the high pressure fuel pump 2 is in the stopped state. This routine is carried out by means of the ECU 15 at each predetermined time interval.

In step S201, it is determined whether the driving duty of the high pressure fuel pump 2 is 0. That is, it is determined whether the high pressure fuel pump 2 is in the stopped state. In this step, it is determined whether the temperature of the fuel in the low pressure fuel passage 4 is in a state where it can go up. Here, note that in this step, it may be determined whether the internal combustion engine is in a state where the high pressure fuel pump 2 can be stopped. In this case, such a determination may be made based on at least one of the number of engine revolutions per minute and the engine load. Also, for example, it may be determined whether the fuel cut is carried out.

In cases where an affirmative determination is made in step S201, the flow goes to step S202 in which the driving duty of the low pressure fuel pump 1 is calculated. At this time, the feed pressure control shown in FIG. 3 is stopped. And a value, which is obtained by adding a prescribed value to the driving duty of the low pressure fuel pump 1 at the time when the high pressure fuel pump 2 is stopped, is set as a new driving duty. Then, the low pressure fuel pump 1 is driven according to the driving duty thus set.

On the other hand, in cases where a negative determination is made in step S201, this routine is ended, and subsequently, the feed pressure control shown in FIG. 3 is carried out. Here, note that in this embodiment, the ECU 15, which carries out the processing of step S201, corresponds to a feed pressure increasing unit in the present invention.

Here, note that in step S202, the prescribed value added to the driving duty of the low pressure fuel pump 1 may also be as a constant or fixed value, but may also be a value which is made larger in accordance with a stop period of time of the high pressure fuel pump 2. That is, the longer the stop period of time of the high pressure fuel pump 2, the more the amount of heat which the fuel receives from the internal combustion engine increases. For this reason, the longer the stop period of time of the high pressure fuel pump 2, the higher the temperature of the fuel in the low pressure fuel passage 4 becomes, and the easier it becomes to generate vapor.

In contrast to this, if the feed pressure is made higher by making the driving duty of the low pressure fuel pump 1 larger as the stop period of time of the high pressure fuel pump 2 becomes longer, the generation of vapor can be suppressed. That is, the longer the stop period of time of the high pressure fuel pump 2, the larger the prescribed value added to the driving duty of the low pressure fuel pump 1 is made, in step S202. Here, note that the relation between the stop period of time of the high pressure fuel pump 2 and an amount of increase of the feed pressure from a point in time at which the high pressure fuel pump 2 is stopped has been obtained through experiments, etc., in advance. In this manner, by deciding the feed pressure according to the stop period of time of the high pressure fuel pump 2, it is possible to suppress the generation of vapor as well as to suppress the feed pressure from being raised more than needed. Accordingly, the electric power consumption of the low pressure fuel pump 1 can be reduced, so that the deterioration of fuel economy can be suppressed.

Moreover, the driving duty of the low pressure fuel pump 1 may also be made larger in the manner as shown in FIG. 6. FIG. 6 is a flowchart showing a flow or routine for the feed pressure control at the time of increasing the driving duty of the low pressure fuel pump 1 according to the stop period of time of the high pressure fuel pump 2. This routine is carried out by means of the ECU 15 at each predetermined time interval. Here, note that for those steps in which the same processing as in the above-mentioned flow is carried out, the same symbols are attached and an explanation thereof is omitted.

In cases where an affirmative determination is made in step S201, the flow advances to step S301. In step S301, the driving duty of the low pressure fuel pump 1 is calculated. At this time, the feed pressure control shown in FIG. 3 is stopped. And a value, which is obtained by adding a prescribed value to the driving duty of the low pressure fuel pump 1 at the current point in time, is set as a new driving duty. Then, the low pressure fuel pump 1 is driven according to the driving duty thus set. Here, note that the prescribed value referred to herein may be the same as that used in step S202, or may be a different value.

In step S302, a state of driving the low pressure fuel pump 1 according to the driving duty calculated in step S301 is maintained for a prescribed period of time.

In step S303, it is determined whether the driving duty of the low pressure fuel pump 1 has exceeded the upper limit value thereof. This upper limit value is set, for example, as a value above which, if the driving duty is increased, there will be almost no influence on the generation of vapor. That is, in cases where the effect of suppressing the generation of vapor will not be substantially changed even if the driving duty of the low pressure fuel pump 1 is increased, the electric power consumption thereof is suppressed by suppressing the driving duty of the low pressure fuel pump 1 from being increased more than that (the upper limit value).

In cases where an affirmative determination is made in step S303, the flow goes to step S304 in which the driving duty of the low pressure fuel pump 1 is set to the upper limit value. The low pressure fuel pump 1 is driven according to the driving duty thus set.

On the other hand, in cases where a negative determination is made in step S303, the flow returns to step S201. That is, the driving duty of the low pressure fuel pump 1 is increased by the prescribed value in step S301, and this state is maintained for the prescribed period of time in step S302, with these steps being carried out in a repeated manner. By doing so, the driving duty of the low pressure fuel pump 1 is increased by the prescribed value at each prescribed period of time. That is, the driving duty of the low pressure fuel pump 1 becomes larger in a stepwise manner. Here, note that the prescribed value and the prescribed period of time can be beforehand obtained through experiments, etc., as values with which it is possible to suppress the generation of vapor.

In this manner, the longer the stop period of time of the high pressure fuel pump 2, the larger the driving duty of the low pressure fuel pump 1 is made, until the driving duty of the low pressure fuel pump 1 exceeds the upper limit value. According to this, the feed pressure can be made higher according to the rise in the temperature of the fuel, so that the generation of vapor can be suppressed. In addition, the driving duty of the low pressure fuel pump 1 is gradually increased until it exceeds the upper limit value, thus making it possible to suppress the electric power consumption of the low pressure fuel pump 1.

Further, when the high pressure fuel pump 2 is stopped, the low pressure fuel pump 1 may be operated continuously, but may instead be operated intermittently. Here, when the high pressure fuel pump 2 is in the stopped state, the fuel in the low pressure fuel passage 4 is not consumed. For this reason, it is sufficient to operate the low pressure fuel pump 1 only for the purpose of maintaining or increasing the pressure of the fuel in the low pressure fuel passage 4. That is, the low pressure fuel pump 1 need only be operated so as to maintain the feed pressure at a level at which vapor is not generated. For example, an operating period of time for which the low pressure fuel pump 1 is operated and a period of time for which the low pressure fuel pump 1 is stopped have been obtained through experiments, etc., in advance. At this time, the operating period of time is set to a necessary minimum which can suppress the generation of vapor. In this manner, by operating the low pressure fuel pump 1 in an intermittent manner, the electric power consumption of the low pressure fuel pump 1 can be reduced, thus making it possible to improve fuel economy.

In addition, the amount of increase in the driving duty of the low pressure fuel pump 1 from the point in time of the stop of the high pressure fuel pump 2 may be decided according to the temperature of the cooling water in the internal combustion engine. Here, note that the temperature of the cooling water in the internal combustion engine may also be replaced by the temperature of the internal combustion engine or the temperature of lubricating oil in the internal combustion engine. Here, the higher the temperature of the cooling water in the internal combustion engine, the larger the rise in temperature of the fuel in the low pressure fuel passage 4 becomes, so the easier it becomes to generate vapor.

FIG. 7 is a time chart showing the changes over time of the temperature of the fuel, the temperature of the cooling water, and the temperature of the intake air, and the temperature of the lubricating oil, at the time of traveling of the vehicle. Here, note that the temperature of the fuel is the temperature of the fuel in an entrance or inlet of the high pressure fuel pump 2.

It is understood that when the temperature of the cooling water or lubricating oil becomes high, the temperature of the fuel goes up. That is, there is a correlation between the temperature of the cooling water or the temperature of the lubricating oil, and the temperature of the fuel. Accordingly, by increasing the driving duty of the low pressure fuel pump 1 according to the temperature of the cooling water, the generation of vapor can be suppressed. The relation between the amount of increase in the driving duty of the low pressure fuel pump 1 with which vapor is not generated and the temperature of the cooling water in the internal combustion engine is obtained through experiments, etc., in advance. Such a relation may have been made into a map.

FIG. 8 is a flow chart showing a flow or routine for the feed pressure control at the time of deciding the driving duty of the low pressure fuel pump 1 according to the temperature of the cooling water in the internal combustion engine. This routine is carried out by means of the ECU 15 at each predetermined time interval. Here, note that for those steps in which the same processing as in the above-mentioned flow is carried out, the same symbols are attached and an explanation thereof is omitted.

In cases where an affirmative determination is made in step S201, the flow advances to step S401. In step S401, the temperature of the cooling water in the internal combustion engine is detected by the cooling water temperature sensor 20. In this step, the temperature of the cooling water in the internal combustion engine is detected as a physical quantity which is in correlation with the temperature of the fuel.

In step S402, the driving duty of the low pressure fuel pump 1 is calculated. At this time, the feed pressure control shown in FIG. 3 is stopped. Then, the amount of increase in the driving duty of the low pressure fuel pump 1 corresponding to the temperature of the cooling water is calculated. The relation between the temperature of the cooling water and the amount of increase in the driving duty of the low pressure fuel pump 1 may be beforehand obtained through experiments, etc., and may be made into a map. Then, a value, which is obtained by adding the amount of increase calculated in this step to the driving duty of the low pressure fuel pump 1 at the time when the high pressure fuel pump 2 is stopped, is set as a new driving duty.

In this manner, when the temperature of the cooling water in the internal combustion engine is high, the generation of vapor can be suppressed. In addition, when the temperature of the cooling water in the internal combustion engine is low, the electric power consumption of the low pressure fuel pump 1 can be reduced, thus making it possible to improve fuel economy.

In addition, the amount of increase in the driving duty of the low pressure fuel pump 1 may be decided according to a difference between the temperature of the cooling water in the internal combustion engine and the temperature of the intake air in the internal combustion engine.

Here, FIG. 9 is a view showing the relation among the temperature of the fuel, the temperature of the cooling water, the temperature of the lubricating oil, and the temperature of the intake air, at the time of traveling of the vehicle. Here, it is understood that the temperature of the intake air has a high correlation with the temperature of the fuel. In contrast to this, the temperature of the cooling water is controlled by means of a thermostat or a radiator, so its correlation with the temperature of the fuel is relatively low. In addition, the temperature of the lubricating oil changes according to the temperature of the cooling water, so its correlation with the temperature of the fuel is relatively low, too.

On the other hand, the temperature of the cooling water in the internal combustion engine has a high correlation with the temperature of the internal combustion engine. For this reason, the difference between the temperature of the cooling water in the internal combustion engine and the temperature of the intake air in the internal combustion engine is in proportion to the amount of the heat which the fuel receives from the internal combustion engine. Accordingly, by increasing the driving duty of the low pressure fuel pump 1 according to the difference between the temperature of the cooling water in the internal combustion engine and the temperature of the intake air in the internal combustion engine, it is possible to increase the feed pressure according to the amount of the heat received by the fuel. Here, note that, the relation between the amount of increase in the driving duty of the low pressure fuel pump 1 from the point in time of the stop of the high pressure fuel pump 2, and the difference between the temperature of the cooling water in the internal combustion engine and the temperature of the intake air in the internal combustion engine is obtained through experiments, etc., in advance. Such a relation may have been made into a map.

FIG. 10 is a flow chart showing a flow or routine for the feed pressure control at the time of deciding the driving duty of the low pressure fuel pump 1 according to the temperature of the cooling water in the internal combustion engine. This routine is carried out by means of the ECU 15 at each predetermined time interval. Here, note that for those steps in which the same processing as in the above-mentioned flow is carried out, the same symbols are attached and an explanation thereof is omitted.

In step S501, the temperature of the intake air in the internal combustion engine is detected by the intake air temperature sensor 17. In this step, the temperature of the intake air in the internal combustion engine having a high correlation with the temperature of the fuel is detected.

In step S502, the driving duty of the low pressure fuel pump 1 is calculated. At this time, the feed pressure control shown in FIG. 3 is stopped. Then, the amount of increase in the driving duty of the low pressure fuel pump 1 corresponding to the difference between the temperature of the cooling water and the temperature of the intake air is calculated. The relation between the difference between the temperature of the cooling water and the temperature of the intake air, and the amount of increase in the driving duty of the low pressure fuel pump 1 may be beforehand obtained through experiments, etc., and may be made into a map. Then, a value, which is obtained by adding the amount of increase calculated in this step to the driving duty of the low pressure fuel pump 1 at the time when the high pressure fuel pump 2 is stopped, is set as a new driving duty.

In this manner, when the amount of the heat received by the fuel is large, the generation of vapor can be suppressed. In addition, when the amount of the heat received by the fuel is small, the electric power consumption of the low pressure fuel pump 1 can be reduced, thus making it possible to improve fuel economy.

### DESCRIPTION OF THE REFERENCE SIGNS

1 low pressure fuel pump

2 high pressure fuel pump

2a suction valve

3 fuel tank

4 low pressure fuel passage

5 high pressure fuel passage

6 delivery pipe

7 fuel injection valves

8 branch passage

9 pressure regulator

10 check valve

11 pulsation damper

12 return passage

13 relief valve

14 communication passage

15 ECU

16 pressure sensor

17 intake air temperature sensor

18 accelerator position sensor

19 crank position sensor

20 cooling water temperature sensor

1. A fuel injection control system for an internal combustion engine in which fuel delivered from a low pressure fuel pump is pressurized by a high pressure fuel pump and is supplied to a fuel injection valve, said system comprising:
a pressure sensor to detect a pressure of fuel between said high pressure fuel pump and said fuel injection valve;
a high pressure fuel pump control unit configured to carry out proportional plus integral control of said high pressure fuel pump so that a detected value of said pressure sensor comes close to a target value;
a low pressure fuel pump control unit configured to decrease a feed pressure, which is a pressure of fuel between said low pressure fuel pump and said high pressure fuel pump, when said high pressure fuel pump is in operation and when an integral term in said proportional plus integral control does not change or is decreasing, and to raise said feed pressure when said high pressure fuel pump is in operation and when said integral term is increasing; and
a feed pressure increasing unit configured to make said feed pressure higher when said high pressure fuel pump is in a stopped state than before said high pressure fuel pump is stopped.

2. The fuel injection control system for an internal combustion engine as set forth in claim 1, wherein
the time when said high pressure fuel pump is in the stopped state is a time of fuel cut of said internal combustion engine.

3. The fuel injection control system for an internal combustion engine as set forth in claim 1, wherein
said feed pressure increasing unit makes said feed pressure higher as a period of time in which said high pressure fuel pump is in the stopped state becomes longer.

4. The fuel injection control system for an internal combustion engine as set forth in claim 1, wherein
said feed pressure increasing unit operates said low pressure fuel pump in an intermittent manner.

5. The fuel injection control system for an internal combustion engine as set forth in claim 1, wherein
said feed pressure increasing unit makes said feed pressure higher as a temperature of cooling water in said internal combustion engine is higher.

6. The fuel injection control system for an internal combustion engine as set forth in claim 1, wherein
said feed pressure increasing unit makes said feed pressure higher as a difference between a temperature of cooling water in said internal combustion engine and a temperature of intake air is larger.
